(19) United States
(12) Patent Application Publication
(10) Pub. No.: US 2018/0281877 A1
(43) Pub. Date: Oct. 4, 2018

(54) SYSTEM FOR QUICK COUPLING AND UNCOUPLING OF A TRACKED UNIT WITH RESPECT TO A CHASSIS OF A TRACKED MACHINE, PARTICULARLY A TRACKED PIPE LAYING MACHINE

(71) Applicant: EURO PIPELINE EQUIPMENT S.P.A., Milano (IT)

(72) Inventor: Fernando PICCININI, Carpaneto Piacentino (IT)

(73) Assignee: EURO PIPELINE EQUIPMENT S.P.A., Milano (IT)

(21) Appl. No.: 15/762,310

(22) PCT Filed: Sep. 21, 2016
(86) PCT No.: PCT/EP2016/072459

§ 371 Date: Mar. 22, 2018

(30) Foreign Application Priority Data
Sep. 24, 2015 (IT) 102015000054740

(51) Int. Cl. B62D 55/084; B62D 55/06

(52) U.S. Cl. CPC B62D 55/084; B66C 23/44; B62D 55/06

(57) ABSTRACT

A system for quick coupling and uncoupling of a tracked unit with respect to a chassis of a tracked machine, particularly a tracked pipe laying machine, includes
at least two supporting structures, configured to be associated with a chassis of a tracked machine. Each one of the two supporting structures includes at least one fixed pin and at least one pin that can move axially along its own longitudinal axis,
and at least two coupling devices, configured to be associated with a tracked unit, wherein each coupling device has at least one hook and at least one slot.

In a configuration for coupling the tracked unit to the chassis, the hook is mated with the fixed pin and the movable pin is inserted in the slot.

### TECHNICAL FIELD

The present disclosure relates to a system for quick coupling and uncoupling of a tracked unit with respect to a chassis of a tracked machine, particularly a tracked pipe laying machine.

### BACKGROUND

In the field of tracked machines, such as for example earth-moving machines or other special machines such as pipe laying machines, the difficulties, costs and time involved in transporting these machines in building sites, due to their space occupation, are known.

In particular, in a tracked machine, the truck is the element that has the largest space occupation, since it must have dimensions, in particular in terms of width, such as to ensure the stability of the machine during all operations at the building site. Tracked assemblies, or tracked units, in fact protrude generally to the sides of the central body of the machine and lead to widths of the machine that are incompatible with transport on roads or railroads and require special measures even for transport on ships.

Accordingly, in order to be able to be transported, for example in a building site or in a maintenance workshop, tracked machines need to be at least partially disassembled and subsequently reassembled in place by means of very laborious operations.

### SUMMARY

The aim of the present disclosure is to provide a system for quick coupling and uncoupling of a tracked unit with respect to a chassis of a tracked machine that simplifies and accelerates the disassembly and reassembly operations.

Within this aim, the present disclosure provides a quick coupling and uncoupling system that allows easy removal and equally easy reinstallation of the tracked units of a tracked machine.

The disclosure further provides a quick coupling and uncoupling system that can be installed also on existing tracked machines.

The disclosure also provides a quick coupling and uncoupling system that is capable of giving the greatest assurances of reliability and safety in use.

The disclosure provides a quick coupling and uncoupling system that is easy to provide and economically competitive if compared with the background art.

This aim, as well as these and other advantages that will become better apparent hereinafter, are achieved by providing a system for quick coupling and uncoupling of a tracked unit with respect to a chassis of a tracked machine, particularly a tracked pipe laying machine, characterized in that it comprises:
at least two supporting structures, configured to be associated with a chassis of a tracked machine, each one of said two supporting structures comprising at least one fixed pin and at least one pin that can move axially along its own longitudinal axis,
at least two coupling devices, configured to be associated with a tracked unit, each coupling device comprising at least one hook and at least one slot,

in a configuration for coupling said tracked unit to said chassis, said hook being mated with said fixed pin and said movable pin being inserted in said slot, said quick coupling and uncoupling system comprising an actuator that is connected to said movable pin in order to produce its axial movement, said actuator being arranged laterally to said movable pin.

This aim, as well as these and other advantages that will become better apparent hereinafter, are further achieved by providing a tracked machine, particularly of the pipe laying type, comprising a quick coupling and uncoupling system as defined above.

### BRIEF DESCRIPTION OF THE DRAWINGS

Further characteristics and advantages of the present disclosure will become better apparent from the description of a preferred but not exclusive embodiment of a system for quick coupling and uncoupling of a tracked unit with respect to a chassis of a tracked machine, illustrated by way of nonlimiting example with the aid of the accompanying drawings, wherein:

FIG. 1 is a perspective view of a tracked pipe laying machine comprising a quick coupling and uncoupling system according to the disclosure;

FIG. 2 is a perspective view of a chassis of a tracked pipe laying machine, comprising the quick coupling and uncoupling system according to the disclosure;

FIG. 3A is an enlarged-scale view of FIG. 3, showing a part of the quick coupling and uncoupling system according to the disclosure in a first operating configuration;

FIG. 3B is an enlarged-scale view of FIG. 3, showing a part of the quick coupling and uncoupling system according to the disclosure in a second operating configuration;

FIG. 4 is a perspective view of a tracked unit of a tracked pipe laying machine, comprising the quick coupling and uncoupling system according to the disclosure;

FIG. 5A is a transverse sectional view of the quick coupling and uncoupling system according to the disclosure in a first operating configuration; and

FIG. 5B is a transverse sectional view of the quick coupling and uncoupling system according to the disclosure in a second operating configuration.

### DETAILED DESCRIPTION OF THE DRAWINGS

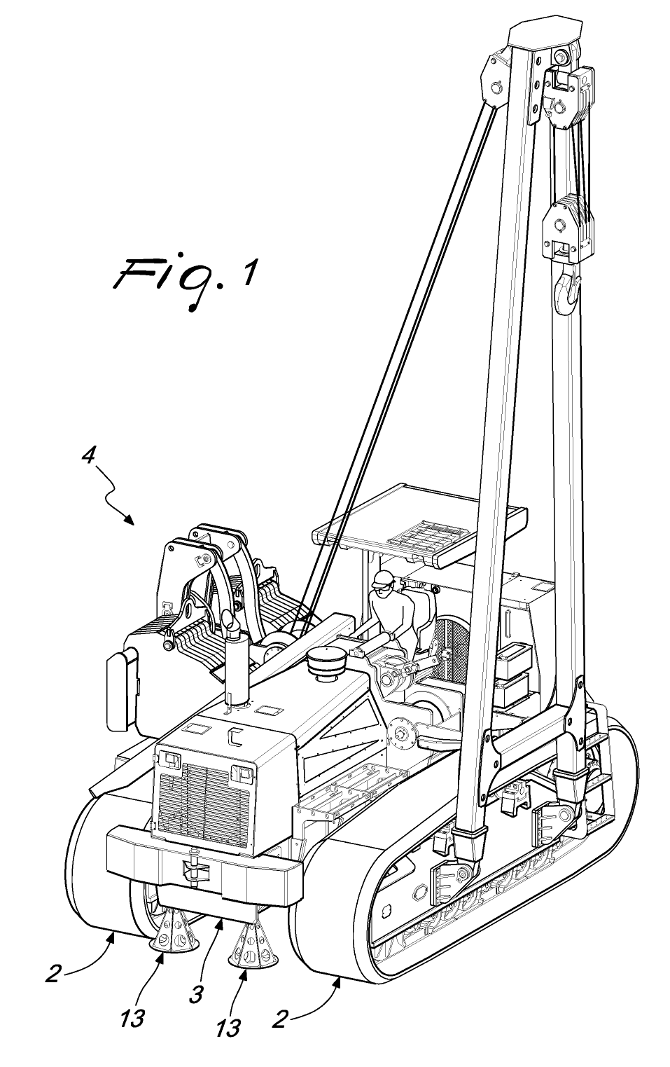

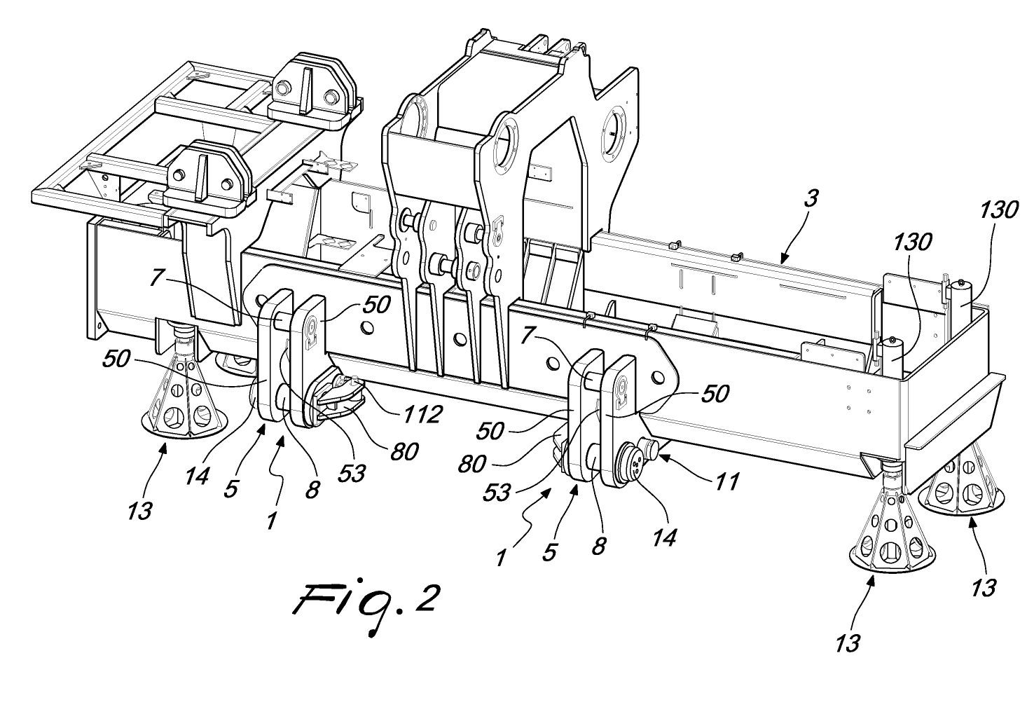

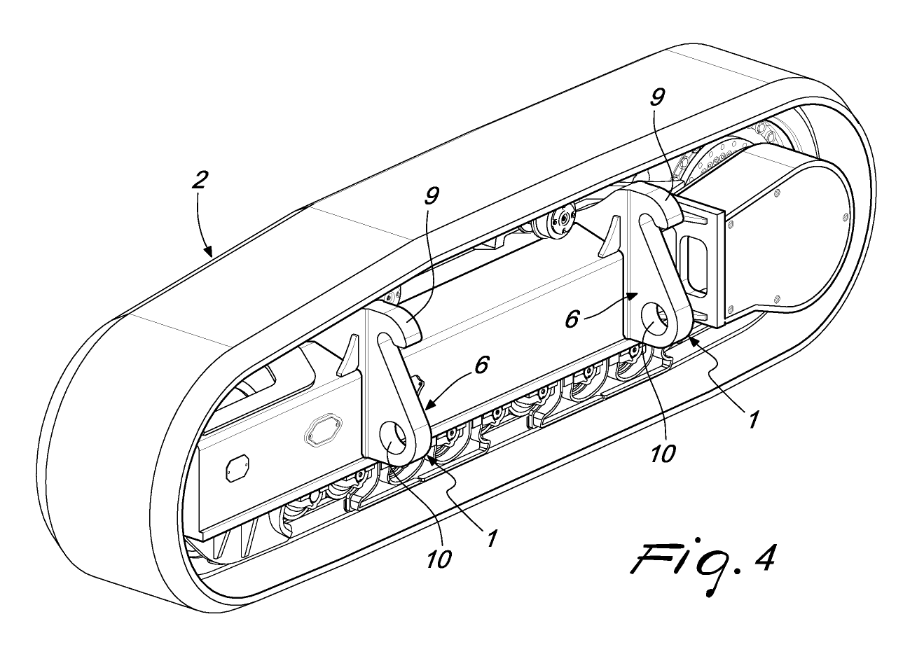

With reference to FIGS. 1-5B, a system for the quick coupling and uncoupling of a tracked unit with respect to a chassis of a tracked machine is designated generally by the reference numeral 1. The tracked unit, the chassis and the tracked machine as a whole are designated respectively by the reference numerals 2, 3 and 4.

According to the disclosure, the quick coupling and uncoupling system 1 comprises:

at least two supporting structures 5, configured to be associated with a chassis 3 of a tracked machine 4, wherein each one of the two supporting structures 5 comprises at least one fixed pin 7 and at least one pin 8 that can move axially along its own longitudinal axis,

at least two coupling devices 6, configured to be associated with a tracked unit 2, wherein each coupling device 6 comprises at least one hook 9 and at least one slot 10.

In a configuration for coupling the tracked unit 2 to the chassis 3, the hook 9 is mated with the fixed pin 7 and the movable pin 8 is inserted in the slot 10. The quick coupling and uncoupling system 1 further comprises an actuator 11 that is connected to the movable pin 8 in order to produce its axial movement. The actuator 11 is arranged laterally to the movable pin 8 and not coaxially.

Advantageously, the actuator 11 is arranged parallel to the longitudinal axis of the movable pin 8.

Advantageously, furthermore, the actuator 11 is at least partially accommodated in the supporting structure 5, preferably in a region of the supporting structure 5 proximate to the chassis 3 of the tracked machine 4.

This arrangement of the actuator 11 ensures its protection against any impacts, for example against the ground or against other components of the machine 4.

Advantageously, in fact, the actuator 11 can be embedded in the structural work of the supporting structure 5 itself.

The movable pin 8 advantageously comprises a connecting arm 80, while the actuator 11 advantageously comprises a slider 110 which can move axially, so that one end 111 of the movable slider 110 is pivoted to the connecting arm 80. In this manner the axial movement of the movable slider 110 is transmitted to the movable pin 8 by means of the connecting arm 80.

The movable slider 110 can comprise, at the end 111, a pivot 112, while the connecting arm 80 can comprise a hole 81 in which the pivot 112 is inserted, so that the pivot 112 and the hole 81 substantially form a hinge coupling.

Advantageously, the hole 81 is elongated in a direction of extension that is substantially perpendicular to the axial direction of motion of the movable pin 8, so as to allow the pivot 112 small movements in a direction at right angles to the axial direction.

This solution ensures the presence of a mechanical play capable of preventing, during the axial motion of the movable pin 8, controlled by the movable slider 110 by means of the connecting arm 80, the generation of unwanted transverse forces and moments due to less-than-perfect parallel arrangement between the direction of axial motion of the movable pin 8 and the direction of axial motion of the movable slider 110.

Advantageously, the supporting structure 5 comprises a pair of protruding lugs 50. The fixed pin 7 is fixed between the protruding lugs 50. The movable pin 8 can slide through a pair of slots 51 provided respectively in each of the two protruding lugs 50.

The coupling device 6 can be inserted advantageously in the pair of protruding lugs 50 of the supporting structure 5. Substantially, the protruding lugs 50 can act as a guide for the correct coupling of the coupling device 6.

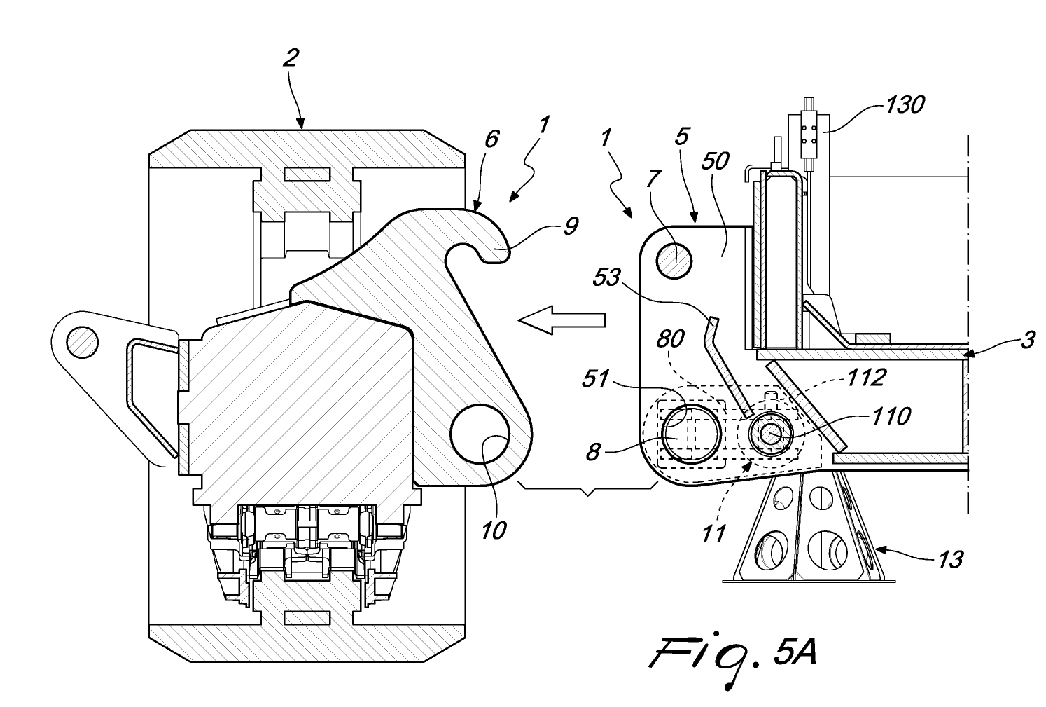

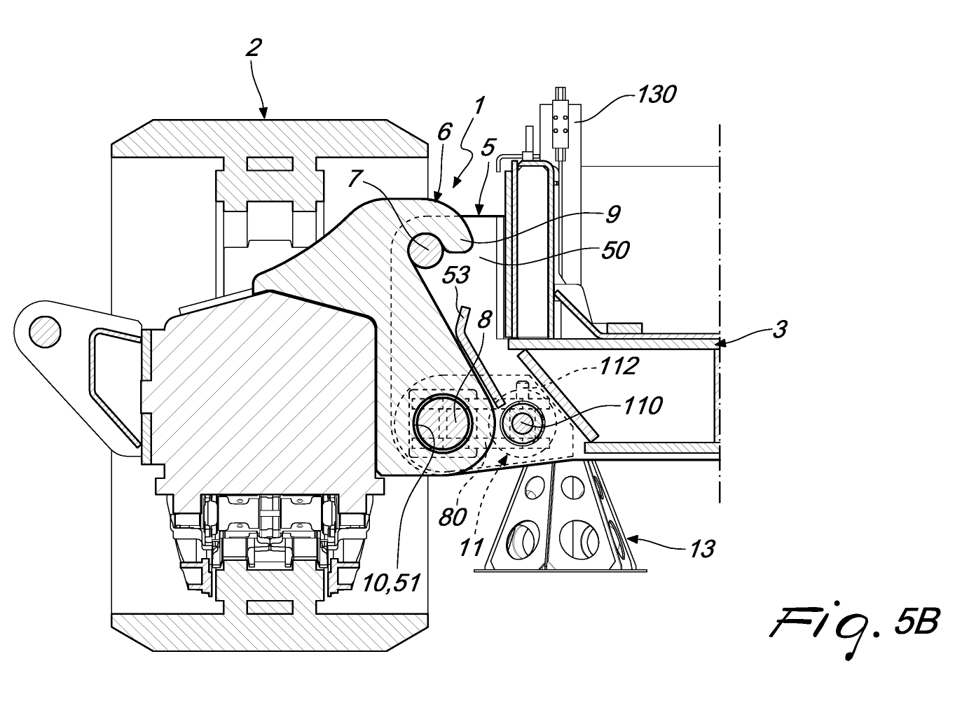

Advantageously, the supporting structure 5 comprises, between the two protruding lugs 50, an abutment plate 53. The coupling device 6 is adapted, once the hook 9 is in position on the fixed pin 7, due to the force of gravity, to abut against the abutment plate 53 so that the slot 10 of the coupling device 6 is aligned with the pair of slots 51 of the supporting structure 5, as shown in particular in FIG. 5B.

In this manner, the movable pin 8 can pass through both the pair of slots 51 and the slot 10, fixing the coupling device 6 to the supporting structure 5 and thus fixing the tracked unit 2 to the chassis 3 of the tracked machine 4.

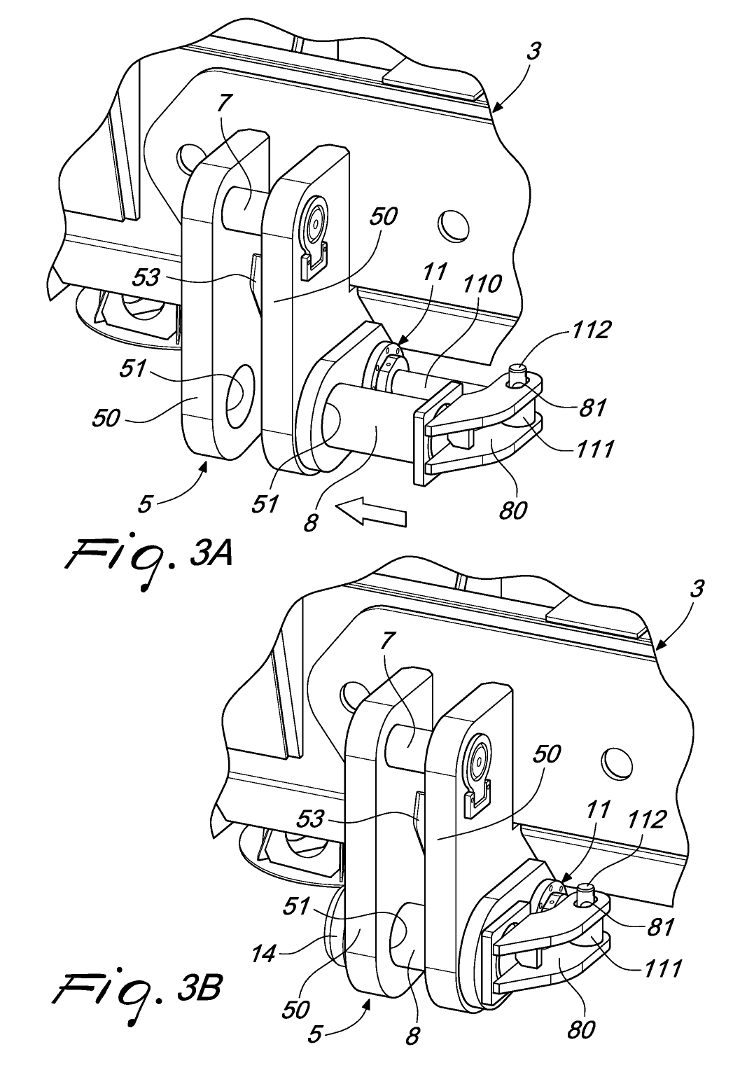

FIG. 3A shows the extracted position of the movable pin 8, while FIG. 3B shows the position of insertion of the movable pin 8; in this figure the coupling device 6 is not shown.

The actuators 11 can be actuated both by an operator onboard the machine and by an operator on the ground with a remote control.

In the configuration for coupling the tracked units 2 to the chassis 3, it is possible to associate advantageously with the movable pin 8, by means of an operator, a safety cap 14, which is adapted to prevent the accidental actuation of the actuator 11 from causing an unwanted uncoupling of the tracked units 2. The safety cap 14 in fact prevents, after removal by the operator, the extraction of the movable pin 8 from the slot 10 of the coupling device 6.

Advantageously, the safety cap 14 can be associated with the movable pin 8 by means of a plurality of fastening screws.

Advantageously, the quick coupling and uncoupling system 1 can also comprise a plurality of lifting feet 13 which are configured to be associated with the chassis 3 and are adapted to lift the tracked machine 4 with respect to the ground in order to take its weight off the tracked units 2 and allow their quick coupling or uncoupling.

The lifting feet 13 can each comprise a linear actuator 130.

The present disclosure also relates to a tracked machine 4, particularly of the pipe laying type, which comprises a pair of tracked units 2 and a chassis 3 and comprises a system 1 for the quick coupling and uncoupling of the tracked units 2 with respect to the chassis 3, as described above.

Operation of the quick coupling and uncoupling system is described briefly hereinafter.

The quick uncoupling of the tracked units 2 from the chassis 3 of the tracked machine 4 mainly provides for the following steps:

extraction of the movable pin 8 from the slot 10 of the coupling device 6;

lifting, for example by means of a crane, of the tracked unit 2 with respect to the chassis 3 of the tracked machine 4, so as to disengage the hook 9 from the fixed pin 7;

removal of the tracked unit 2 from the chassis 3.

These steps are generally preceded by the following steps:

activation of the lifting feet 13 in order to lift the tracked machine 4 off the ground;

removal, by an operator, of the safety cap 14, so as to free the movable pin 8.

The coupling of a tracked unit 2 to the chassis 3 of a tracked machine 4 mainly provides for the following steps:

lifting, for example by means of a crane, of the tracked unit 2 to such a height that the hook 9 is at a height from the ground that is greater than the height from the ground of the fixed pin 7;

movement of the tracked unit 2 toward the chassis 3 and lowering of the tracked unit 2 so as to allow the engagement of the hook 9 with the fixed pin 7;

due to gravity, and thanks to the presence of the abutment plate 53, the tracked unit 2 is arranged so that the slot 10 of the coupling device 6 is aligned with the movable pin 8, which is still in the extracted position;

insertion of the movable pin 8 in the slot 10 of the coupling device 6.

These steps are generally preceded by the step of activation of the lifting feet 13 in order to lift the tracked machine 4 off the ground.

When the movable pin 8 is inserted in the slot 10, an operator can apply the safety cap 14.

In practice it has been found that the quick coupling and uncoupling system according to the present disclosure achieves the intended aim and advantages, since it allows to remove simply and quickly tracked units from tracked machines.

Another advantage of the quick coupling and uncoupling system according to the disclosure resides in that it can be installed even on existing tracked machines by means of structural work that can be performed in workshops suitable for this purpose.

A further advantage of the quick coupling and uncoupling system according to the disclosure resides in that the actuator, which is the most delicate component of the system, is protected against impacts against the ground or against any components of the tracked machine due to its position.

Another advantage of the quick coupling and uncoupling system according to the disclosure resides in that it reduces the transport costs of tracked machines, since once the tracked units have been disassembled, the chassis of the machine, complete with the main components, can be easily containerized in a container.

The quick coupling and uncoupling system thus conceived is susceptible of numerous modifications and variations.

Furthermore, all the details may be replaced with other technically equivalent elements.

In practice, the materials used, so long as they are compatible with the specific use, as well as the contingent shapes and dimensions, may be any according to requirements.

The disclosures in Italian Patent Application No. 102015000054740 (UB2015A003881) from which this application claims priority are incorporated herein by reference.

1-10. (canceled)

11. A system for quick coupling and uncoupling of a tracked unit with respect to a chassis of a tracked machine, particularly a tracked pipe laying machine, comprising:
at least two supporting structures, configured to be associated with a chassis of a tracked machine, each one of said two supporting structures comprising at least one fixed pin and at least one movable pin that can move axially along its own longitudinal axis,
at least two coupling devices, configured to be associated with a tracked unit, each coupling device comprising at least one hook and at least one slot,
in a configuration for coupling said tracked unit to said chassis, said hook being mated with said fixed pin and said movable pin being inserted in said slot, said quick coupling and uncoupling system comprising an actuator that is connected to said movable pin in order to produce its axial movement, said actuator being arranged laterally to said movable pin.

12. The quick coupling and uncoupling system according to claim 11, wherein said actuator is arranged parallel to the longitudinal axis of said movable pin.

13. The quick coupling and uncoupling system according to claim 11, wherein said actuator is accommodated at least partially in said supporting structure, in a region of said supporting structure proximate to said chassis of said tracked machine.

14. The quick coupling and uncoupling system according to claim 11, wherein said movable pin comprises a connecting arm, said actuator comprising a slider that can move axially, one end of said movable slider being pivoted to said connecting arm, the axial movement of said movable slider being transmitted to said movable pin by means of said connecting arm.

15. The quick coupling and uncoupling system according to claim 14, wherein said movable slider comprises, at said end, a pivot, said connecting arm comprising a hole in which said pivot is inserted.

16. The quick coupling and uncoupling system according to claim 15, wherein said hole is elongated in a direction of extension that is substantially perpendicular to the axial direction of motion of said movable pin.

17. The quick coupling and uncoupling system according to claim 14, wherein said supporting structure comprises a pair of protruding lugs, said fixed pin being fixed between said protruding lugs, said movable pin being able to slide through a pair of slots provided respectively in each one of said protruding lugs.

18. The quick coupling and uncoupling system according to claim 17, wherein said coupling device can be inserted within said pair of protruding lugs of said supporting structure.

19. The quick coupling and uncoupling system according to claim 17, wherein said supporting structure comprises, between said pair of protruding lugs, an abutment plate, said coupling device being adapted to abut against said abutment plate so that said slot of said engagement device is aligned with said pair of slots of said supporting structure.

20. A tracked machine, particularly of the pipe laying type, comprising a pair of tracked units and a chassis, further comprising a system for the quick coupling and uncoupling of said tracked units with respect to said chassis according to claim 11.
